(19) United States
(12) Patent Application Publication
(10) Pub. No.: US 2005/0235708 A1
(43) Pub. Date: Oct. 27, 2005

(54) Lock apparatus

(75) Inventor: Renny Tse-Haw Ling, Jhonghe City (TW)

Correspondence Address: LADAS & PARRY, 26 WEST 61ST STREET, NEW YORK, NY, 10023, US

(73) Assignee: SINOX COMPANY LTD.

(21) Appl. No.: 11/109,230

(22) Filed: Apr. 19, 2005

(30) Foreign Application Priority Data
Apr. 23, 2004 (TW) 093111331

(51) Int. Cl. E05B 37/02

(52) U.S. Cl. 70/30; 70/312

(57) ABSTRACT

A lock apparatus, including: a lock housing and a peripheral member detachably mounted to the lock housing, a combination lock mechanism and a resetable member provided in the lock housing, the combination lock mechanism having a lock shaft, at least one rotating sleeve engaging over the lock shaft and a dial wheel engaging over the rotating sleeve, wherein the resetable member includes a retaining portion that serves to lock the peripheral member that is attached to the lock housing, or to restrict the rotating sleeve from rotation when a user intends to set a new combination code by rotating the dial wheel.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to a lock apparatus capable of receiving and locking more than one peripheral member to the lock housing, particularly to one to be implemented with a combination lock.

### BACKGROUND

It is found that the conventional code-setting combination locks all include a lock shaft, plural collars, plural dial wheels, and a resetable button. When a user intends to set a new combination code, a force is applied to the resetable button when the lock shaft is at its unlocked state, for driving the resetable button to press the collars, thereby disengaging projections provided to peripheries of the collars from indents formed on the dial wheels, and causing wedges provided to the lock shaft to engage into notches formed on the collars for restricting rotation of the collars. Under such a circumstance, the user is able to reset a new combination code for unlocking the lock by rotating the dial wheels to designated digits.

However, since the resetable button provided to the conventional combination lock can only serve to set a new combination code, which function is not frequently employed by the users in actual applications, some users do not even incline to purchase lock apparatus featured with a code-setting function. An improved lock apparatus that features the code-setting device with additional locking effects can thus enhance the value and to expand the possible applications of the lock apparatus.

The lock apparatus in accordance with the present invention has thus been developed to overcome the drawbacks found in the prior art.

### SUMMARY OF INVENTION

Accordingly, it is a primary object of this invention to make improvements to the conventional code-setting combination lock mechanism, where the resetable member may drive the rotating sleeves to displace along a lengthy direction the lock shaft within two different ranges that provide the lock apparatus with locking and code-setting effects, respectively.

It is another object of this invention to provide a lock apparatus where a peripheral member may serve to set a new combination code for the lock apparatus or to be attached to the lock apparatus.

It is a further object of this invention to provide a lock apparatus where the peripheral member may be an accessory that may be freely attached to the lock apparatus.

To achieve the object, this invention provides a lock apparatus, comprising: a lock housing, a peripheral member detachably mounted to the lock housing, a combination lock mechanism and a resetable member provided in the lock housing, the combination lock mechanism having a lock shaft, plural rotating sleeves and plural dial wheels, and a resilient member, wherein the resetable member serves to lock the peripheral member in a first position, or to restrict the rotating sleeves from rotation when a user intends to set a new combination code by rotating the dial wheels in a third position.

### BRIEF DESCRIPTION OF THE DRAWINGS

These and other modifications and advantages will become even more apparent from the following detailed description of preferred embodiments of the invention and from the drawings, in which:

FIG. 1 is a schematic drawing illustrating a planar view of a first preferred embodiment of this invention.

FIG. 2 is a perspective view of the first preferred embodiment of this invention.

FIG. 3 is an exploded perspective view of the first preferred embodiment of this invention.

FIG. 4A is a schematic drawing illustrating the peripheral member of this invention being slid into a channel with the first urging face as the leading end.

FIG. 4B is a schematic drawing illustrating the resetable member of this invention being at a first position under a normal state.

FIG. 5 is an enlarged cross sectional view of FIG. 4A along line 4-4 illustrating the lock mechanism of this invention being under the locked state.

FIG. 6 is a schematic drawing illustrating the peripheral member of this invention being slid into a channel with the second urging face as the leading end, and the resetable member of this invention being at a third position.

FIG. 7 is an enlarged cross sectional view of FIG. 6 along line 7-7 illustrating the lock mechanism of this invention being under the unlocked state.

FIG. 8A is a schematic drawing illustrating the operation of the fastening member of this invention.

FIG. 8B is a schematic drawing illustrating the operation of the fastening member of this invention.

FIG. 9A is a schematic drawing illustrating the operation of a second preferred embodiment of this invention.

FIG. 9B is a schematic drawing illustrating the operation of a second preferred embodiment of this invention.

FIG. 10 is a schematic drawing illustrating a third preferred embodiment of this invention.

FIG. 11 is a schematic drawing illustrating a fourth preferred embodiment of this invention.

FIG. 12 is a schematic drawing illustrating a fifth preferred embodiment of this invention.

### DETAILED DESCRIPTION OF THE INVENTION (PREFERRED EMBODIMENTS)

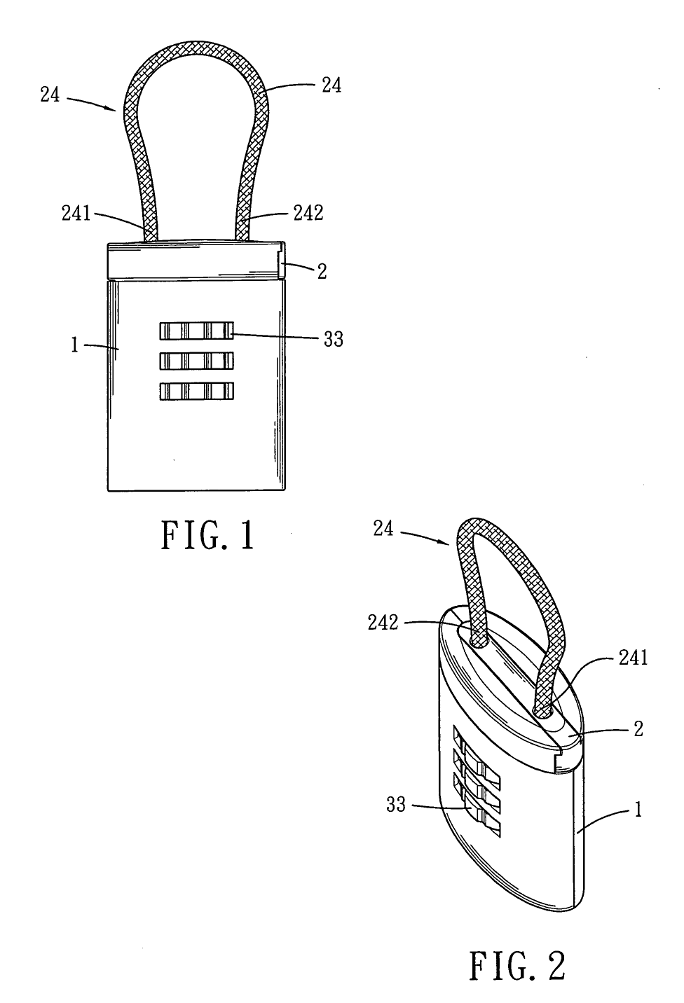

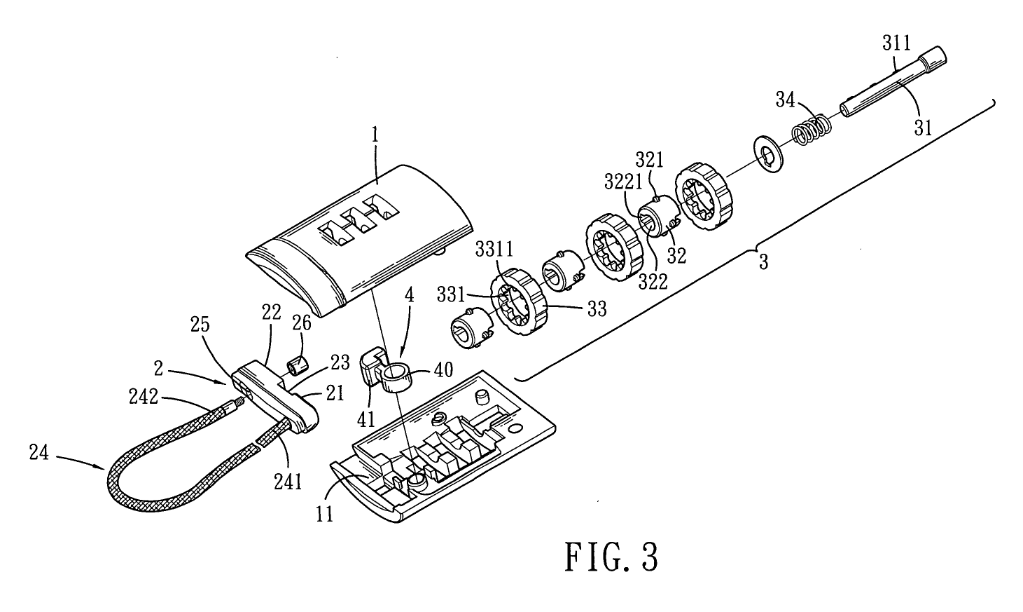

FIGS. 1, 2 and 3, respectively, illustrate a planar view, a perspective, and an exploded perspective view of the first preferred embodiment of this invention. As shown, the lock apparatus of this invention includes: a lock housing 1, a peripheral member 2, a combination lock mechanism 3 and a resetable member 4, wherein the peripheral member 2 is detachably mounted to the lock housing 1, and the combination lock mechanism 3 and resetable member 4 are provided in the lock housing 1.

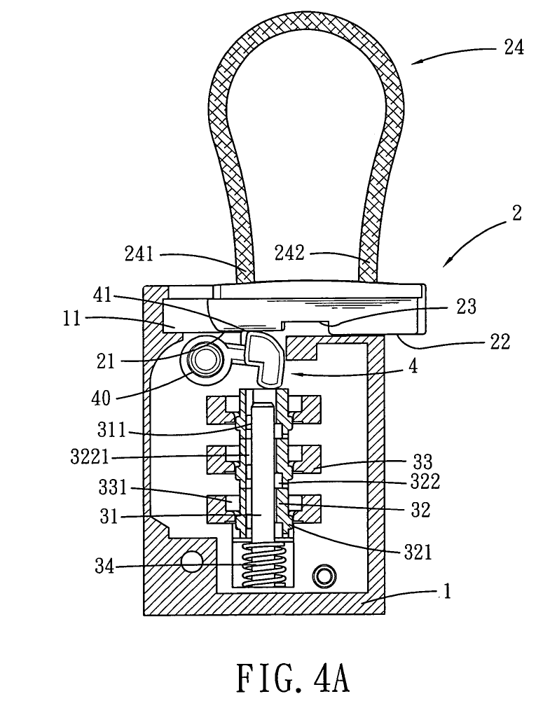

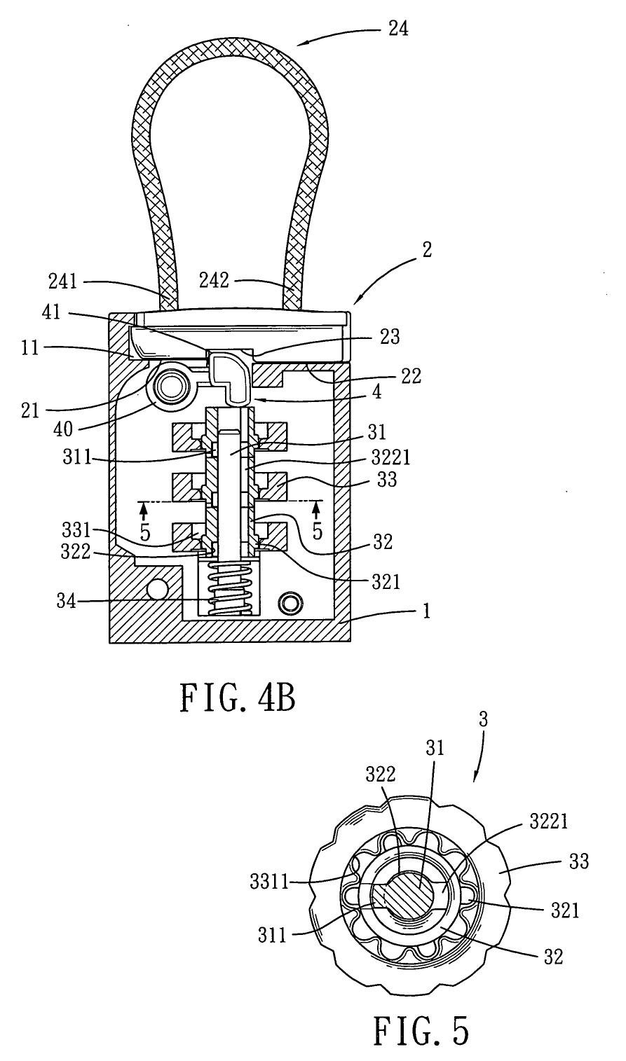

With further reference to FIGS. 4A, 4B, 5, 6 and 7, the combination lock mechanism 3 includes a lock shaft 31, at least one rotating sleeve 32, at least one dial wheel 33 corresponding to the at least one rotating sleeve 32, and a resilient member 34. In the embodiment, there are three rotating sleeves 32 and three dials wheels 33 each corresponding to one of the rotating sleeves 32.

As shown, the lock shaft 31 is provided with plural wedges 311 on an outer periphery thereof.

The plural rotating sleeves 32 are each formed with plural projections 321 on an outer periphery thereof, and a central bore 322 therethrough. A notch 3221 is formed on a wall defining the central bore 322. The central bore 322 of each of the rotating sleeves 32 is engaged over the outer periphery of the lock shaft 31 and the notches 3221 are each engageable with a corresponding wedge 311 provided to the lock shaft 31.

The plural dial wheels 33 are each formed therethrough with a central bore 331 engaging over the outer periphery of the corresponding rotating sleeves 32. Plural indents 3311 are formed on a wall defining the central bore 331. The plural indents 331 are engageable with the projections 321 of the corresponding rotating sleeves 32.

The resilient member 34 is engaged over the lock shaft 31 and constantly applies a resilient force towards the rotating sleeves 32 to normally maintain a constant engagement between the rotating sleeves 32 and the dial wheels 33. Normally, when the rotating sleeves 32 are engaged with the dial wheels 33, the dial wheels 33 and the rotating sleeves 32 would be actutable by an external force to rotate about the lock shaft 31 between an unlock position where the plural projections 321 of the rotating sleeves 32 are aligned with the plural wedges 311 of the lock shaft 31, and a locked position where the plural projections 321 of the rotating sleeves 32 are misaligned from the plural wedges 311 of the lock shaft 31. Thus, to switch between the locked position and the unlocked position, a user would only have to manually rotate the dial wheels 33 to the preset combination code.

When a user rotates the dial wheels 33 to the preset combination code so as to move the rotating sleeves 32 to the unlocked position, the notches 3221 of the plural rotating sleeves 32 are aligned with the corresponding wedges 311 of the lock shaft 31, to allow displacement of the rotating sleeves 32 along a lengthy direction of the lock shaft 31. On the other hand, when the rotating sleeves 32 are at the locked position, the notch 3221 of the rotating sleeves 32 are misaligned from the wedges 311, to impede displacement of the rotating sleeves 32 along the lengthy direction of the lock shaft 31 as they are restricted by the wedges 311.

According to a first embodiment of this invention, the resetable member 4 is pivotally provided to the lock housing 1 and includes a retaining portion 41 extending therefrom. The lock housing 1 is formed thereon with a slideway 11 into which the retaining portion 41 may extend. The slideway 11 also serves to receive the peripheral member 2.

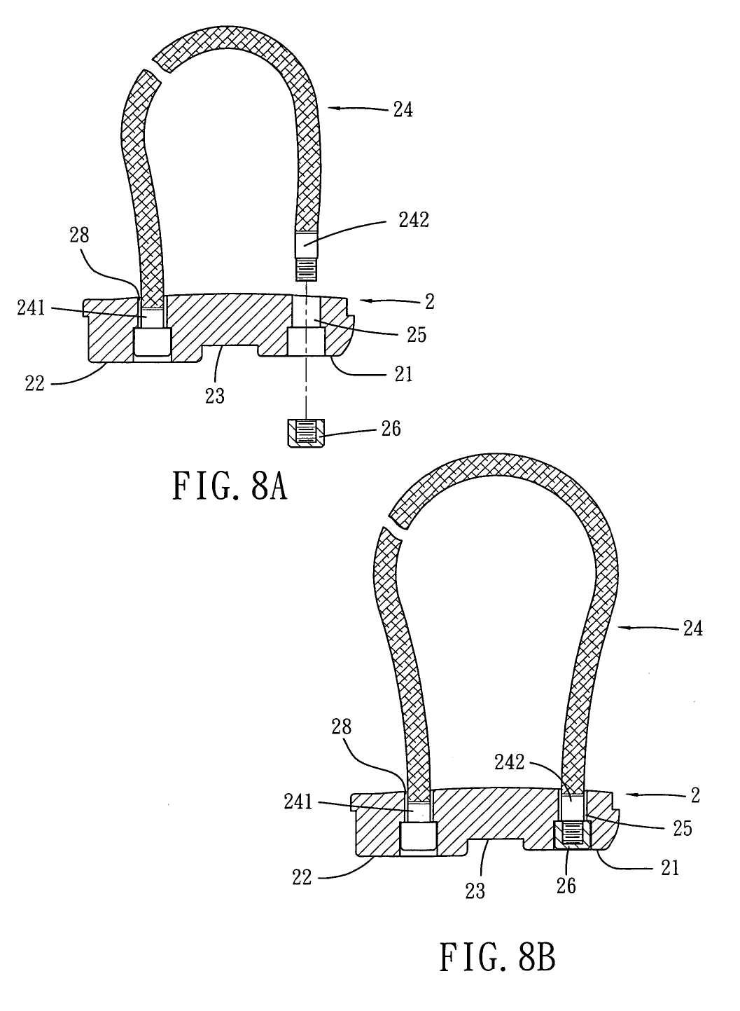

With reference to FIGS. 8A and 8B, in this embodiment, the peripheral member 2 is formed with a stepped configuration including a first urging face 21 and a second urging face 22 of different elevations, and with a retaining dent 23 between the first urging face 21 and the second urging face 22.

The peripheral member 2 is provided thereon with a fastening member 24. In this embodiment, the fastening member 24 is a cable having a fixed end 242 being affixed in a first aperture 28 formed on the peripheral member 2 and a detachable end 241 being detachably inserted into a second aperture 25 formed on the peripheral member 2. The detachable end 241 may be threaded to a fastening member 26 that would then surround an enclosed region in cooperation with the peripheral member 2, such as in the case of strapping the fastening member 24 about an object. The fastening member 24 may alternatively be disengaged from the peripheral member 2 to form a fastening member opening, such as in the case of un-strapping the fastening member 24 from the object. It should be noted that the peripheral member 2 as described is one of many embodiments that may be employed in the present invention and serves as an illustration only.

According to this invention, when a user rotates the dial wheels 33 to the preset combination code so as to move the rotating sleeves 32 to the unlocked position, the resetable member 4 is able to move between a second position and a third position for driving the rotating sleeves 32 to displace along the lengthy direction of the lock shaft 31 within two different ranges.

Under a normal state, the resetable member 4 is constantly maintained to allow engagement and disengagement between the peripheral member 2 and the slideway 11 at a first position and the second position, respectively, due to the rounded configuration of the retaining portion 41 that first encounters the peripheral member 2 upon sliding the peripheral member 2 into the slideway 11.

Accordingly, when the peripheral member 2 is slid into the slideway 11 with the first urging face 21 as the leading end, the first urging face 21 would drive the retaining portion 41 of the resetable member 4 to subsequently cause displacement of the rotating sleeves 32 along the lengthy direction of the lock shaft 31. At this time, the rotating sleeves 32 maintain to be engaged with the dial wheels 33 (as shown in FIG. 4A).

After the peripheral member 2 has been completely slid into the slideway 11, the resetable member 4 returns to the first position due to the resilient force applied by the resilient member 34 and retains the retaining portion 41 in the retaining dent 23 (as shown in FIG. 4B). At this time, the user may rotate the dial wheels 33 to drive the rotating sleeves 32 to the locked position thereby locking the peripheral member 2 in the slideway 11.

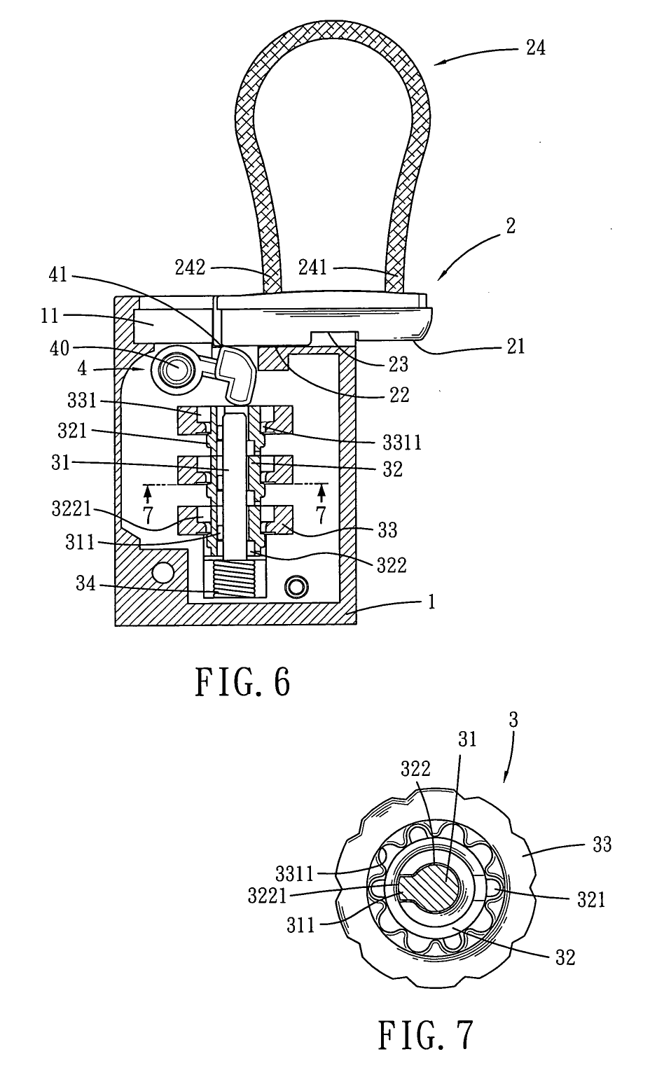

On the other hand, when the peripheral member 2 is slid into the slideway 11 with the second urging face 22 as the leading end, a higher elevation of the second urging face 22 with respect to the first urging face 21 would drive the retaining portion 41 of the resetable member 4 to subsequently cause a larger range of displacement of the rotating sleeves 32 along the lengthy direction of the lock shaft 31 upon sliding the peripheral member 2 into the slideway 11. Under such a larger range of displacement, the projections 321 of the rotating sleeves 32 would be disengaged from the indents 3311 of the dial wheels 33. At this time, the resetable member 4 is at the third position (as shown in FIG. 6) where the wedges 311 of the lock shaft 31 are aligned with the notches 3221 of the rotating sleeves 32 so as to impede rotation of the rotating sleeves upon rotation of the dial wheels 33. Accordingly, the user may rotate the dial wheels 33 at this time to set a new combination code and then withdraw the peripheral member 2 from the slideway 11 upon setting the new combination code.

To prevent from excessive sliding of the second urging face 22 of the peripheral member 2 into the slideway 11, the slideway 11 is preferred to be formed with a stepped configuration (in FIGS. 4A and 6) where an inner end of the slideway 11 has a narrow width to prevent further sliding of the second urging face 22 of the peripheral member 2.

In this embodiment, the resetable member 4 is pivotally provided to the lock housing 4 by means of a pivot portion 40, such that the resetable member 4 is able to pivot between the second position and the third position about the pivot portion 40 for driving the rotating sleeves 32 to displace along the lengthy direction of the lock shaft 31 within the two different ranges based on the different elevations of the first and second urging faces 21, 22.

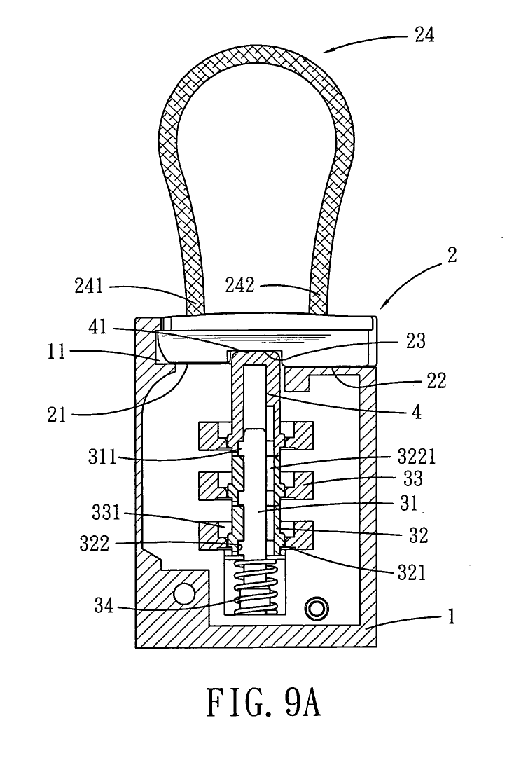

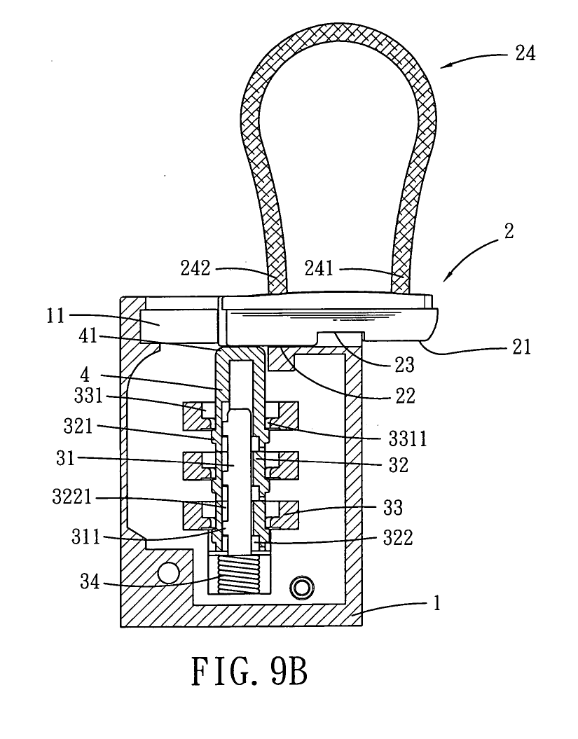

With reference to FIGS. 9A and 9B, according to an alternative embodiment of this invention, the resetable member 4 may be joined to one of the rotating sleeves 32, such as the topmost rotating sleeve, to form an integral unit, such that at the same time of sliding the peripheral member 2 into the slideway 11, the peripheral member 2 would actuate the resetable member 4 to drive the resetable member 4 and to subsequently cause displacement of the rotating sleeves 32 along the lengthy direction of the lock shaft 31, thereby achieving the intended locking or code setting effect by means of the integral unit consisting of a rotating sleeve 32 and a resetable member 4 upon sliding the first urging face 21 or the second urging face 22 of the peripheral member 2 into the slideway 11, respectively.

Alternatively, the topmost rotating sleeve 32 and the resetable member 4 may be independent units rather than an integral unit. In such an embodiment, the resetable member 4 would drive displacement of the rotating sleeves 32 along the lengthy direction of the lock shaft 31 through linear motion along the lengthy direction of the lock shaft 31.

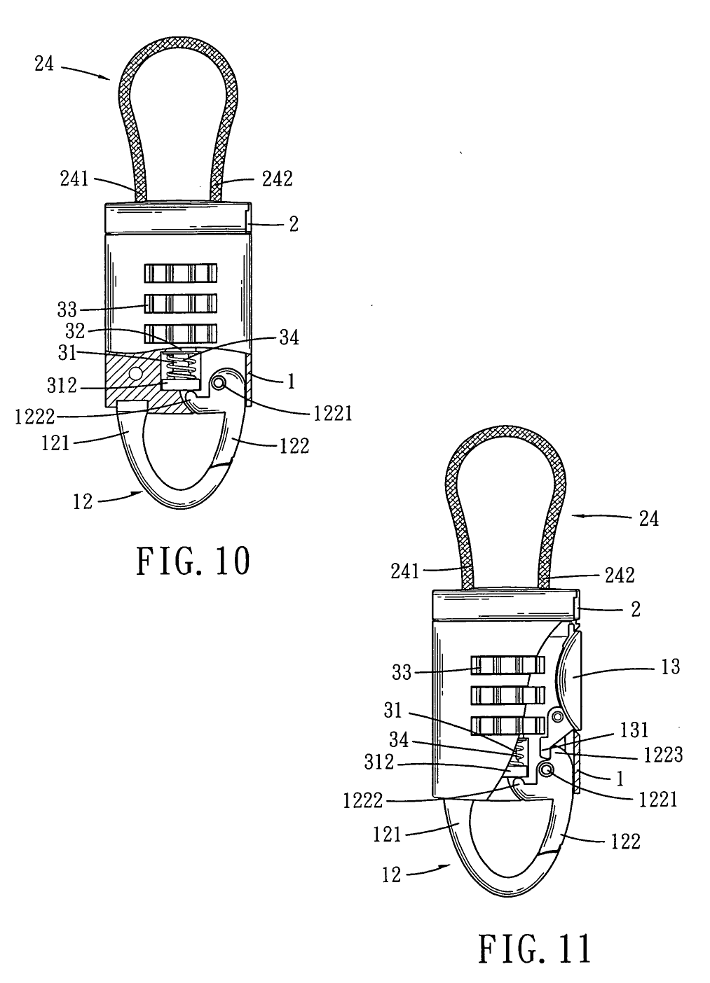

With reference to FIG. 10, the lock housing 1 as shown is further provided with a shackle 12. An enclosed region is surrounded by the shackle 12 and the lock housing 1. The lock shaft 31 is further provided at an end thereof with a stopper 312. The shackle 12 as shown includes a first hook 121 and a second hook 122, wherein the first hook 121 is affixed to the lock housing 1 and the second hook 122 is provided with a pivot portion 1221. The pivot portion 1221 includes an urging piece 1222 that urges against an end face of the stopper 312. As such, when a user rotates the dial wheels 33 to the preset combination code so as to move the rotating sleeves 32 to the unlocked position, the user may push the second hook 122 to subsequently cause displacement of the rotating sleeves 32 along the lengthy direction of the lock shaft 31. Accordingly, a shackle opening is formed at an interface of the first hook 121 and the second hook 122 to allow the user to hook the first hook 121 to an object.

On the other hand, when the rotating sleeves 32 are at the locked position, the lock shaft 31 is prevented from displacement as the notch 3221 of the rotating sleeves 32 are misaligned from the wedges 311 such that the rotating sleeves 32 are restricted by the lock shaft 31 from displacement. Accordingly, the urging piece 1222 would be impeded by the end face of the stopper 312 upon an application of an external force towards the second hook 122, thereby maintaining an enclosed region that is surrounded by the first hook 121, the second hook 122 and the lock housing 1, so as to lock the lock apparatus to the object.

In addition to the peripheral member 2 that is detachably connected to the fastening member 24, the lock housing 1 may be provided with the shackle 12 that surrounds an enclosed region in cooperation with the lock housing 1. These two locking features eliminate the need of providing an additional lock mechanism to the lock apparatus.

However, it should be noted that the specific constructions of the shackle 12 as described for illustrative purpose only, while there are many types of constructions that may be implemented to the shackle 12, such as cables or metal hooks. To facilitate easy opening of the shackle 12, the pivot portion 1221 of the second hook 122 may be further provided with an extension 1223 that cooperates with an actuating arm 131 of a button 13 provided to the lock housing 1, as shown in FIG. 11. Accordingly, upon applying a force to the button 13, the actuating arm 131 of the button 13 would urge against the extension 1223 of the second hook 122 to subsequently cause rotation of the second hook 122. The second hook 122 would in turn cause displacement of the rotating sleeves 32 along the lengthy direction of the lock shaft 31 thereby forming the shackle opening at the interface of the first hook 121 and the second hook 122.

It should also be noted that the cooperation between the button 13 and the second hook 122 is not limited to the embodiment as described above, neither is such cooperation between the button 13 and the second hook 122 a primary feature of this invention.

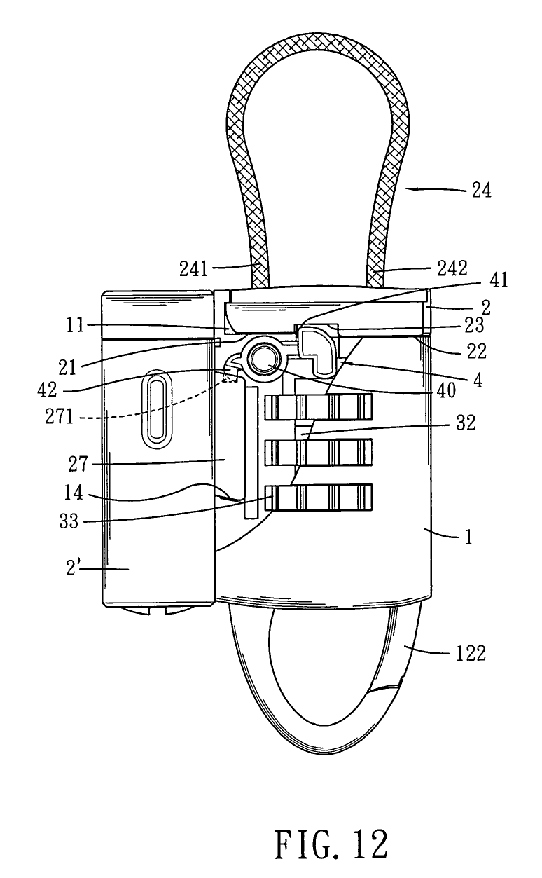

With reference to FIG. 12, according to yet another embodiment of this invention, the resetable member 4 may further be provided with a clasp 42 extending into a groove 14 formed on the lock housing 1. A peripheral member 2′ having a retaining ridge 27 may be attached to the lock housing 1 by inserting the clasp 42 into a cavity 271 formed to the retaining ridge 27. The peripheral member 2′ may be a flashlight, a compass, a keychain or any other tools that the user intends to be attached to the lock housing 1.

According to this invention, application of the second urging face 22 would drive the resetable member 4 to cause the projections 321 of the rotating sleeves 32 to disengage from the indents 3311 of the dial wheels 33, thereby allowing a user to set a new combination code in cooperation with the rotating sleeves 32 the dial wheels 33.

On the other hand, by rotating the dial wheels 33 that are co-acted with the plural rotating sleeves 32 between an unlock position and a locked position in relation to the lock shaft 31, the notches 3221 of the plural rotating sleeves 32 may be manipulated to align with and misalign from the corresponding wedges 311 of the lock shaft 31. When a user rotates the dial wheels 33 to the preset combination code so as to move the rotating sleeves 32 to the unlocked position, application of the first urging face would allow sliding of the peripheral member 2 into the slideway 11 of the lock housing 1 and to subsequently retain the retaining portion 41 of the resetable member 4 in the retaining dent 23 of the peripheral member 2, whereby the resetable member 4 would serve to lock the peripheral member 2 in place upon rotating the dial wheels 33 to drive the rotating sleeves 32 to the locked position.

Thusly, the resetable member 4, as compared to the prior art, serves to allow a user to set a new combination code or to feature the lock apparatus with the locking effect by means of the stepped configuration of the peripheral member 2, including the first urging face 21 and the second urging face 22 of different elevations.

Accordingly, the peripheral member 2 may serve to set a new combination code for the lock apparatus or to be attached to the lock apparatus, wherein the peripheral member 2 may be provided with a fastening member for securing an object or an accessory as desired by the user.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A lock apparatus, comprising:
a lock housing, detachably connected to at least one peripheral member;
a combination lock mechanism, including:
a lock shaft provided in the lock housing;
at least one rotating sleeve engaging over the lock shaft;
at least one dial wheel engaging over the corresponding rotating sleeve; and
a resilient member engaging over the lock shaft and applying a resilient force towards the rotating sleeve to normally maintain a constant engagement between the rotating sleeve and the dial wheel,
wherein when the rotating sleeve is engaged with the dial wheel, the dial wheel is actutable to drive rotation of the rotating sleeve about the lock shaft between a locked and an unlocked position that, respectively, prevents and allows displacement of the rotating sleeve along a lengthy direction of the lock shaft; and
a resetable member, provided in the lock housing and including a retaining portion, the resetable member being normally maintained to allow engagement with one of the at least one peripheral member at a first position and disengagement from the peripheral member at a second position, characterised in that:
the peripheral member is formed with a stepped configuration including a first urging face and a second urging face of different elevations; when the rotating sleeve is at the locked position, the resetable member locks the peripheral member to the lock housing; when the rotating sleeve is at the unlocked position, the peripheral member can be mounted into the lock housing either with the first urging face as the leading end to drive the retaining portion of the resetable member to subsequently cause displacement of the rotating sleeves along the lengthy direction of the lock shaft to move to a second position while the rotating sleeve is still maintained to be engaged with the dial wheel, or with the second urging face as the leading end to drive the retaining portion thereof to subsequently cause a larger range of displacement of the rotating sleeve along the lengthy direction of the lock shaft to move to a third position to allow a user to set a new combination code for the combination lock mechanism.

2. The lock apparatus of claim 1, wherein the resetable member includes a pivot portion for pivoting the resetable member to the lock housing, to allow the resetable member to pivot between the first, the second and the third positions about the pivot portion.

3. The lock apparatus of claim 1, wherein the resetable member is actutable between the second position and the third position through linear motion.

4. The lock apparatus of claim 3, wherein the resetable member is joined to the rotating sleeve to form an integral unit.

5. The lock apparatus of claim 3, wherein the resetable member and the rotating sleeve are independent units.

6. The lock apparatus of claim 1, wherein when the resetable member is at the third position, the rotating sleeve is disengaged from the dial wheel.

7. The lock apparatus of claim 1, wherein lock housing is formed with a slideway into which the peripheral member slides and a retaining dent is disposed between the first urging face and the second urging face for retaining the retaining portion of the resetable member therein.

8. The lock apparatus of claim 1, wherein the peripheral member is provided with a detachable fastening member that surrounds an enclosed region in cooperation with the peripheral member.

9. The lock apparatus of claim 8, wherein fastening member is a cable having a fixed end being affixed to the peripheral member and a detachable end being detachably inserted into an aperture formed on the peripheral member.

10. The lock apparatus of claim 1, wherein resetable member is provided with a clasp, the peripheral member is provided with a retaining ridge, the lock housing is formed with a groove into which the retaining ridge inserts, and the retaining ridge is formed with a cavity into which the clasp inserts.

11. The lock apparatus of claim 1, wherein the lock housing is provided with a shackle and the lock shaft is provided at an end thereof with a stopper, the shackle being movable with respect to the lock housing to form a shackle opening, or being restricted by the stopper to surround an enclosed region in cooperation with the lock housing.

12. The lock apparatus of claim 11, wherein the shackle includes a first hook and a second hook, the first hook being affixed to the lock housing, the second hook being provided with a pivot portion, the pivot portion having an urging piece that urges against the end face of the stopper.

13. The lock apparatus of claim 12, wherein the urging piece of the second hook presses the stopper to cause displacement of the rotating sleeve along the lengthy direction of the lock shaft for a designated range, thereby forming the shackle opening at an interface of the first hook and the second hook.
